(19) United States
(12) Patent Application Publication
(10) Pub. No.: US 2004/0089234 A1
(43) Pub. Date: May 13, 2004

(54) System for spraying a fluid material

(76) Inventors: Soren Hagglund, Goteborg (SE); Bengt-Goran Bengtsson, Bralanda (SE)

Correspondence Address: VMware, Inc., ATTN: Jeffrey Pearce, 3145 Porter Drive, Palo Alto, CA, 94304, US

(21) Appl. No.: 10/702,322

(22) Filed: Nov. 6, 2003

Related U.S. Application Data
(60) Provisional application No. 60/424,555, filed on Nov. 6, 2002.

(51) Int. Cl. B05C 5/00; B05B 7/00; B05C 15/00

(52) U.S. Cl. 118/663; 118/693; 118/300

(57) ABSTRACT

A system for spraying an at least substantially fluid material has a source providing a controllable flow of the material to be sprayed; a dosing unit that receives the flow of material from the source, that holds a quantity of the material in a reservoir, and that outputs the material to a dispensing device; and a control arrangement that has as an input signal an indication of a fill level of the reservoir and that outputs a flow control signal to the source such that the fill level in the reservoir is maintained less than a maximum level and greater than a minimum level when the dispensing device is active. The dosing unit thereby forms an active accumulator able to both receive material from the source and deliver material to the dispensing device at the same time.

### CROSS-REFERENCE TO RELATED APPLICATIONS

This application claims priority from U.S. Provisional Patent Application No. 60/424,555, filed 6 Nov. 2002.

### BACKGROUND OF THE INVENTION

1. Field of the Invention

This invention relates to an arrangement for spraying coating and/or filling materials such as paint, sealants, glue, insulating material, etc.

2. Background Art

A pump, a hose and a spray nozzle that is mounted on a spray gun are often used to spray coating and filling materials onto or into work surfaces. A shut-off valve is typically located in the spray gun, and a flow meter is usually included in the circuit.

Two main types of pumps are used in such spraying arrangements: volume-generating (or, equivalently, flow-generating) pumps and pressure-generating pumps. An example of a volume pump is an electrically driven gear-type pump. Volume-generating pumps usually require no flow transducer. An example of a pressure pump is a pneumatically controlled piston pump, such as a so-called “4-ball” pump, which has the advantage of constant displacement and the same pressure-gain relationship in both directions.

Another type of pump is a single-action piston pump, sometimes referred to as a dosing pump or, especially in the automotive industry, as a “shot meter.” Used with such a pump, the hose between the pump and the gun may be of different types, depending on the pressure regions involved. For high-pressure application, the hose is usually reinforced, which brings the added advantage of providing greater stiffness. Sometimes the spray nozzle is mounted directly on the pump, which is then usually of the shot meter type. If the pump is of the pressure-generating type, the pressure at the gun end is often regulated with a material pressure regulator.

When there is a hose between the pump and the spray nozzle, a pressure drop arises over the hose during spraying. When the gun is shut off, the pressure is constant throughout the hose, but the pressure is higher in the spray gun. When spraying is started, the gun valve is opened. The pump pressure then distributes itself between the hose and the spray gun. The flow out through the nozzle is therefore higher immediately after opening the gun than during steady-state flow. How quickly the pressure drops depends on the elasticity of the hose and its concomitant accumulating effect.

An added complication arises when spraying using industrial robots: flow must often vary depending on such factors as the speed of the robot. In such applications, a volume-generating pump is commonly used, because it can be controlled with very short time constants. With such pumps, however, the flow (as opposed to pressure) into the hose is not the same as the flow out from the hose at the same instant. This is because the accumulating effect (equivalent to a low-pass, integrating characteristic) of the hose causes a strong degradation of control speed when flow changes occur and when the gun is activated. It is also possible to use pressure-generating pumps in such applications, in which case a pressure regulator can then be placed at or near the gun to improve performance.

Sometimes, two parallel single-action piston pumps are used, with one of the pumps being filled at the same time that the other is used to apply the coating or filling material. In order to equalize the pressure during pump change-over, a passive accumulator is often added between the pumps and the spray gun. This greatly reduces the response time of the system, however, even if the piston pumps are driven by an electrical motor and are therefore of the volume-generating type.

Some double-dosing systems include a passive equalizing accumulator. Such arrangements suffer from a very slow control ability.

One general problem of existing spray arrangements, regardless of the type of supply pump used, is that some coating materials may in turn include material that cannot withstand the sheer forces that arise in a material pressure regulator or cannot withstand being forced through the narrow slit that is used in the conventional pressure regulator. One such material, often used in the automotive industry, is low-density PVC that contains small, glass spheres or beads up to about 0.3 mm in diameter. Moreover, the contained glass spheres typically also cannot withstand high static pressure—175 Bar is usually the maximum.

A conventional PVC spray system, for example, operates roughly so: 1) the material to be sprayed is pumped by a drum pump to a robot unit; 2) a booster pump (for example, a 4-ball pump) raises the pressure from about 50-100 Bar to a constant, regulated 200 Bar; 3) a somewhat elastic hose 5-15 m long leads material to the robot; 4) a flow transducer of the gear-driven, impulse transducer type measures flow; 5) a material-pressure regulator is located at the robot and regulates the spray pressure down to 50-150 Bar; and 6) a hose 1-3 m long leads material to the spray gun, which has one or more suitable nozzles.

A ball and seat arrangement is typically used to regulate pressure in these conventional systems—material flows when the ball is lifted from its seat. This creates a very small opening, especially at low flow rates. This also means, however, that there will be a large pressure drop over the ball, which further damages contained glass structures.

It is not possible to use a conventional pressure regulator with such material because it tends to crush the spheres; similarly, a flow transducer of the gear-driven type is also unsuitable because it grinds the material to pieces. Gear-driven, volume-generating pumps and gear-based transducers cannot be used for the same reason. Coating materials of this sort should therefore be pumped and transported in such a way that the glass spheres are not crushed and so that other characteristics of the material are not changed. In this context, for example, no more than a 3% change in density is normally permitted from “drum to gun.”

What is needed is a system that overcomes the disadvantages of the conventional systems described above for spraying coating and filling materials. The system should be able to spray even material that contain structures such as glass spheres or beads without damaging these structures. The invention provides such an arrangement.

### SUMMARY OF THE INVENTION

The invention provides a system for spraying any fluid material, including those with inhomogeneities such as glass beads, and those without, as described in the attached patent claims.

In particular, a system for spraying an at least substantially fluid material is provided that comprises a source providing a controllable flow of the material to be sprayed; a dosing unit that receives the flow of material from the source, that holds a quantity of the material in a reservoir, and that outputs the material to a dispensing device; and a control arrangement that has as an input signal an indication of a fill level of the reservoir and that outputs a flow control signal to the source such that the fill level in the reservoir is maintained less than a maximum level and greater than a minimum level when the dispensing device is active. The dosing unit thereby forms an active accumulator able to both receive material from the source and deliver material to the dispensing device at the same time.

According to a further aspect of the invention, the system includes a dosing pressure sensor that generates a dosing pressure signal corresponding to a dosing pressure of material from the dosing unit to the dispensing device; and a pressure adjustment arrangement in the dosing unit that adjusts a pressure applied to the reservoir in response to a dosing control signal. The control arrangement then has, as additional input signals, the dosing pressure signal and a reference flow value, and generates the dosing control signal such that the pressure adjustment arrangement adjusts the dosing pressure to cause a material flow from the dispensing device at least substantially equal to the reference flow value when the dispensing device is activated.

In one exemplifying embodiment, the source includes a first pump; the dosing unit comprises a second pump; the first pump produces a pump output flow of the material in response to the flow control signal; and the second pump receives the material output under pressure from the first pump and holds a dosage volume of the material in the reservoir: The control then generates the flow control signal also as a function of the pump output flow.

According to yet another aspect of the preferred embodiment of the invention, the control arrangement generates the flow control signal also as a function of the pump output flow and generates the flow control signal and the dosing control signal such that the reservoir of the second pump is gradually filled with material when the dispensing device is not dispensing material.

The invention is particularly advantageous in applications in which the fluid material includes inhomogeneities. This is because all material passages in a flow path through the first and second pumps may be made larger than a maximum dimension of the inhomogeneities, which thereby pass undestroyed through the flow path. One example of a material with inhomogeneities is a PVC material with inhomogeneities such as glass beads or spheres that have lower density than the PVC.

In implementations in which the source includes the first pump, this pump is advantageously a constant-displacement flow pump such as a pneumatically controlled piston pump. A 4-ball pump is an example of a suitable pump of this type.

A first elastic hose may be used to connect the first pump to the second pump. In this case, the hose will have a first accumulation volume and the reservoir of the dosing unit will preferably have a maximum operating volume that exceeds the first accumulation volume over an operating pressure region.

### BRIEF DESCRIPTION OF THE DRAWINGS

FIG. 1 illustrates the main components of a spray-control system according to the invention.

FIG. 2 illustrates the main components and parameters of one exemplifying embodiment of a spray-control system according to the invention.

FIG. 3 illustrates one example of a used in an exemplifying embodiment of the invention to generate a reference control signal for a flow pump.

### DETAILED DESCRIPTION

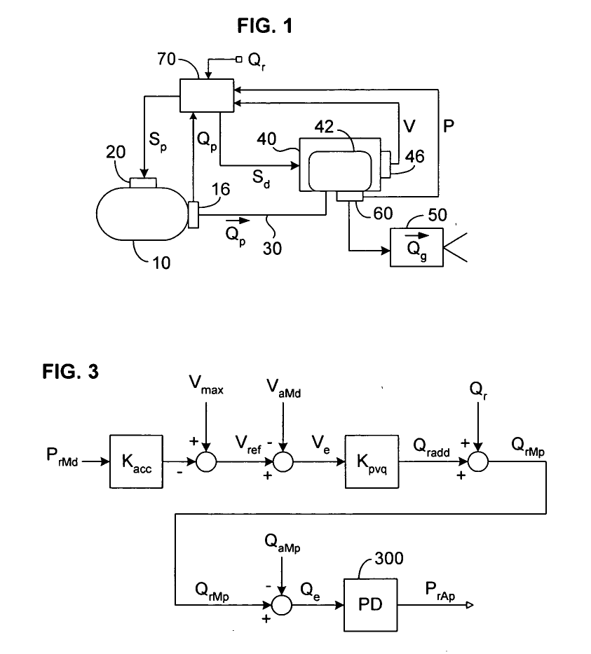

FIG. 1 illustrates the invention in broadest terms: Material to be sprayed is supplied with a controllable flow Qₚ from a source 10 to a dosing unit 40 via one or more conduits or hoses 30. A sensor 16 measures the flow Qₚ. The dosing unit holds a volume V of the material in a reservoir 42 from which material is supplied on demand to a dispensing device 50 such as a spray gun, which dispenses a material flow Q_{g}. The volume V may vary between a maximum volume (completely full) and a minimum volume (such as completely empty). A volume sensor 46 generates a signal V that indicates how full the reservoir 42 is. A pressure sensor 60 measures the pressure P of material being delivered from the dosing unit 40 to the dispensing device 50.

Based on the signals V, P and Qₚ, as well as a desired material flow Qᵣ, a control system 70 generates two control signals: S_{d}, applied to the dosing unit 40 to cause it to adjust the pressure P to maintain the flow of material Q_{g} as close as possible to the desired flow Qᵣ; and Sₚ, applied to the source 10, to cause it to adjust the flow Qₛ to maintain the volume V held in the reservoir 42 at a level between maximum and minimum in order to allow for both increases and decreases in pressure. When the dispensing device 50 is activated and spraying material, the reservoir 42 can be both receiving material from the source 10 and delivering it to the dispensing device at the same time. The dosage device thus acts as an active accumulator between the source 10 and the dispensing device 50.

Depending on the components used, the invention achieves the active accumulator with no need for any slits and no large pressure changes anywhere in the material flow path from the source to the dispensing device. This makes the invention particularly well-adapted for use even with coating materials that contain such relatively fragile structures as glass spheres or other inhomogeneities in that there will be no passage through which the material must pass will need to pass through any opening smaller than an approximate maximum dimension of the inhomogeneities (such as diameter of the spheres), and no pressure change great enough to destroy the inhomogeneities. Other examples of inhomogeneities that are advantageously sprayed using the invention include all forms of embedded particles, both solid and elastic, fluids (including emulsions) or even micro-bubbles of gas that have a different density from the primary coating material. The invention may also be used, however, simply to achieve a faster control system, for example, for applying paint or other homogeneous material using a gear-driven pump and long hoses.

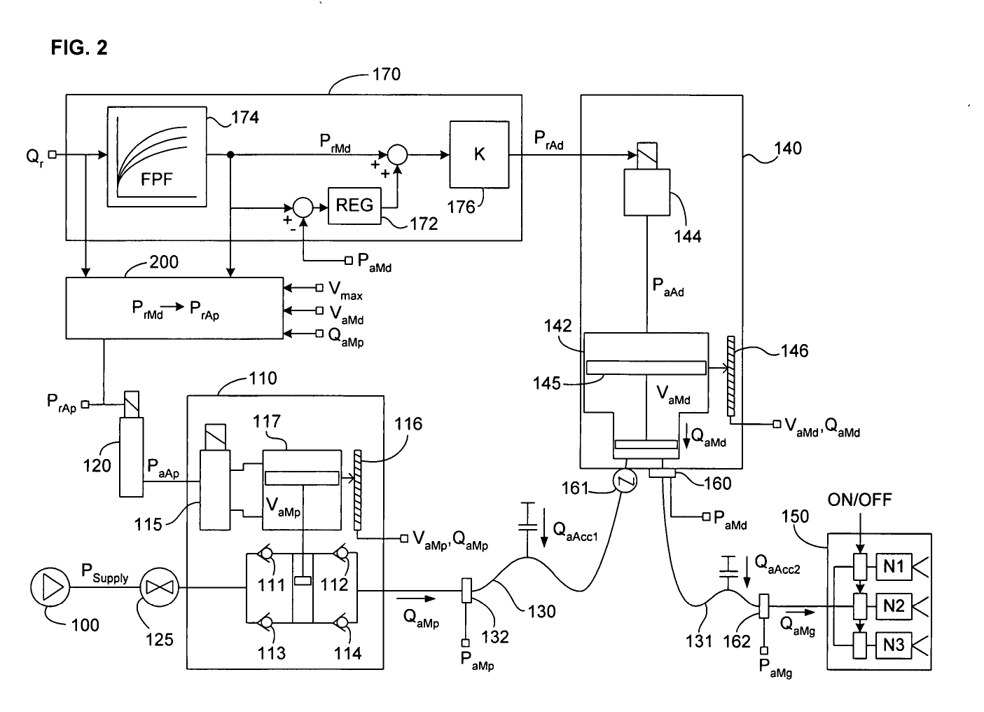

FIG. 2 illustrates one exemplifying implementation of the concepts of the invention. The main components in this implementation are: A first pump, for example, a flow pump, which provides a flow-regulated volume of material, and a pressure-regulated dosing unit (a second pump) that acts as a controlled, active accumulator that is used for pressure regulation. If the first pump is of the pressure-controlled type (as in FIG. 2) then it is advantageously flow-feedback controlled as shown in FIG. 4. The invention avoids large pressure drops and requires no slit at all.

Several values for pressure, flow and volume are referred to in this application. To aid in interpretation, any pressure, flow or volume value in the form N_{iJk} follows the convention:

N=“P”—a pressure value

“Q”—a flow value

“V”—a volume value

i=“r”—a reference or set or desired value

“a”—an actual or measured value

J=“A”—air

“M”—material

k=“p”—at the input or output of, or within, a flow pump 110

“d”—at the input or output of, or within, a dosing unit 140

“g”—at the input of or within a spray gun

Thus, for example, P_{rAd} is a reference air pressure applied to the dosing unit 140 ; Q_{aMp} is a value indicating actual material flow from the pump 110; and so on. Symbols for values that do not follow this naming convention are explained where they are first mentioned.

The desired coating or filling material is supplied at a pressure P_{Supply} from any known supply system 100, such a typical drum pump and distribution system, to the first pump 110. The supply system 100 and first pump 110 therefore correspond to the source 10 in FIG. 1.

In the illustrated embodiment, the first pump 110 is a pressure pump, for example, of the pneumatically controlled 4-ball type. Other arrangements may be used instead of the 4-ball pump, however. For example, the four check valves 111-114 in the 4-ball pump could be replaced by a 4/2 valve, in which case the 4/2 valve should be controlled in any known manner in phase with the usual control air exchange to the pump motor in order to further reduce any impact on the material, since the check valves must also be pressed upward by the material. Another advantage of the controlled material valve on the pump is that it can be controlled so as to lie out of phase relative to the air-control valve—the pump will then lower the material pressure instead of raising it; moreover, such a 4/2 controlled intake valve would also allow the operating pressure to be reduced actively, using known techniques.

The supply pressure P_{Supply} is preferably at least approximately constant and should be lower than the pressure required for the lowest positive flow to be used. In applications such as spraying coating material in the automotive industry, the supply pressure P_{Supply} will normally lie in the range 20-50 Bar.

In the illustrated embodiment of the invention, the first, flow pump 110 is controlled using a conventional proportional valve pump 120 that has a reference air pressure P_{rAp} and a delivered, output air pressure P_{aAp}.

An alternative, simple way to provide a flow-controllable material source 10 would be to replace the first pump 110 and control valve 120 with a pressure-regulated, pressurized supply 100 and a flow meter. Pressure regulation could even be as simple as “on-off,” such that material would be “pulsed” to the dosing unit. This alternative will be attractive in implementations in which low cost is an important factor.

In most applications, the user will know what flow rate Qᵣ is needed, but not necessarily what reference air pressure P_{rAp} is needed to achieve this flow. One way to generate P_{rAp} from a reference material pressure P_{rMd}, which in turn is derived in a hardware or software conversion module 200 from Qᵣ and certain other predetermined or measured parameters, is described below with reference to FIG. 3.

Any conventional pump (including a gear-driven pump or even a double-dosing pump) may be used as the first, flow pump 110 as long as it does not damage the material and can be controlled as a function of pressure or flow. In tests of a prototype of the invention, for which the pump 110 was a pneumatically controlled 4-ball pump, the pump 110 had a volume of 400 cm³ and a pressure gain of 1:40. Air was supplied using an electronically regulated proportional valve 120 that had an input reference pressure P_{rAp} and an output pressure P_{aAp} in the range 0-6 Bar. The output pressure P_{aAp} was applied to a bi-directional valve 115, which was controlled using a standard circuit (not shown), and whose dual output air lines were connected on either side of a piston within a cylinder 117 in the pump 110.

Flow was measured using a calibrated position sensor 116 directly connected to the pump 110, which was calibrated to indicate the actual filled volume V_{aMp} of the cylinder 117. Since flow is simply the time derivative of volume, and piston position will indicate current, actual filled volume, a measurement of the change of position can therefore be converted into flow using known expressions; thus, since it gives instantaneous measurements of V_{aMp}, the sensor 116 also gives information sufficient to calculate (or generate, using analog components) the instantaneous flow value Q_{aMp} from the pump 110. In the illustrated embodiment, Q_{aMp} corresponds to Qₛ. shown in FIG. 1. Suitable position sensors include linear potentiometers (used in prototypes of the invention), optical or mechanical encoders, differential transformers, etc.

It would also be possible to measure flow Q_{aMp} directly using a standard flow meter at the output of the source 10 (here, pump 110). Such sensors will in general be both slower and less accurate than using the calibrated position sensor 116, but may in some implementations have other advantages when used with a given source 10.

It is advantageous to include a controlled inlet valve 125 between the supply 100 and the first pump 110, especially if a 4-ball pump is used that does not lower the pressure. During periods of low use the supply 100 can then be kept open and then shut off so that the dosing unit 140 will be filled during spraying, after which the dosing unit 140 can operate as a pure accumulator for some time. When the volume in the dosing unit 140 has dropped below a predetermined level, the supply is once again opened to fill the dosing unit 140.

Material is fed at the flow rate Q_{aMp} via a first hose 130, to the dosing unit 140, which may be implemented using, for example, a single-action pump. The pressure at the flow pump (upstream) end of the hose 130 may be measured using a standard transducer 132 and is indicated as P_{aMp}.

The dosing unit 140 may be of the type known as a “shot meter,” which is mentioned above. The dosing unit 140 is preferably located near (for example, within 2 m) or even on or in a dispensing device such as a spray gun (or wand, etc.) 150 and is pressure-regulated to a spray pressure that strives to cause the flow Q_{aMg} (which corresponds to Q_{g} in FIG. 1) dispensed by the gun 150 to be equal to the desired flow Qᵣ.

In FIG. 2, the spray gun 150 is shown as having three nozzles N1, N2, N3, each with a respective on/off valve. The number of nozzles (including only one) and the on/off valve arrangement will of course often differ from application to application; the invention may be used with any number of nozzles and with any type of on/off devices, as long as they do not themselves degrade the characteristics of the material to be sprayed.

The dosing unit 140 includes a cylinder 142 that acts as the reservoir 42 (FIG. 1) and holds a volume V_{aMd} (corresponding to V in FIG. 1) of the material to be sprayed. The dosing unit 140 is preferably also controlled using a proportional valve 144 similar to the valve 120 used to control the flow pump 110, although it may have a different size. As shown in FIG. 2, this valve 144 takes, as an input signal, a reference air pressure P_{rAd}, and converts this into an actual, applied air pressure P_{aAd} which is applied to influence the position of the main piston 145 within the cylinder 142.

A position sensor 146 (such as a linear potentiometer) is also mounted on the dosing unit 140 to determine the instantaneous value of V_{aMd}, that is, the volume of material held in the reservoir/cylinder 142. The sensor 146 thus corresponds to the sensor 46 shown in FIG. 1. Given the diameter of the cylinder, the position of the piston 145 will determine the volume V_{aMd} of material held in the cylinder at any given time. The net flow Q_{aMd} into and/or out of the cylinder will be the time derivative of V_{aMd}. The sensor 146 therefore generates information sufficient to determine either value, or both. Conversely, if, instead of a position sensor such as sensor 146, a flow meter were used as the sensor 46 (FIG. 1), then volume could be determined through integration. One disadvantage of this solution would be the need for an integration constant in order to determine absolute volume; another disadvantage would be the need for periodic calibration to remove drift.

Recall that the dosing unit 140 may be receiving new material from the first pump 110 at the same time it is delivering it to the spray gun 1 50. Moreover, flow may actually be negative: For example, if the elasticity of the second hose 131 is great enough, then when the gun is shut off some material may flow back into the dosing unit. Similarly, depending on the type of device used as the source—such as a 4-ball pump—then excess volume in the dosing unit could be fed back from the dosing unit 140 to the source.

The main cylinder 142 in the dosing unit 140 should have a maximum operating volume that exceeds the accumulation volume of the first and second hoses 130, 131 over the pressure region that is to be used. When the spray gun 150 is shut off and at the lowest desired pressure, the dosing unit 140 could be completely filled with material. If the dosing unit 140 is pressurized to the highest spray pressure, however, there should be a residual volume sufficiently large so that the material can be applied during the entire time it takes the first pump 110 to get started and to supply more material to the dosing unit 140. Skilled mechanical engineers will be able to choose an appropriate maximum volume for the cylinder 142 given the accumulation volume of the first hose 130 and maximum flow specifications of the spray gun 150.

The invention is advantageous even in applications in which the spray gun 150 is maneuvered by a robot. In such applications, the dosing unit 140 may be located at the robot itself, which, in normal installations, means that the hose 130 between the first, flow pump 110 and the dosing unit 140 will typically be 5-15 m long. A second hose 131 that feeds the spray gun 150 from the dosing unit 140 is preferably as short as possible given the needs of the chosen application of the invention. For manual or robotic spraying in the automotive industry, this hose 131 will typically be in the range of 1-3 meters long.

If the flow pump 110 is chosen to be a constant-displacement pump, then one can easily arrange for local circulation of material back from the gun 150 to a position between the inlet valve 125 and the pump 110 itself using a return hose (not shown) and a valve at the gun. The dosing unit 140 should then be pressurized sufficiently to enable this circulation. This of course does not rule out circulation of material directly to the supply drum pump 100 instead.

A pressure transducer 160 measuring the actual output pressure P_{aMd} is preferably located at, on, or as close as possible to the output of the dosing unit 140. Note that the output pressure P_{aMd} will also indicate the input pressure of material to the cylinder, as well as the pressure of the material within the cylinder itself. In applications that would need to measure input or interior pressure, additional transducers will therefore typically not be necessary; moreover, because of the pressure equality from input to output, the pressure transducer 160 could be at the input to the reservoir of the dosing unit 140, or even in direct contact with its interior.

Because the main 10, 110 to the gun 150, or to absorb material from this flow, it would also be possible to combine the first and second hoses into a single hose, whereby the connection with the dosing unit is a single conduit (for example, a hose) connected to a T-joint in the single hose. The pressure transducer 160 would still provide the value of the pressure P_{aMd} of material delivered to the gun.

The output signal P_{aMd} from the transducer 160 is used as a subtractive input to a regulator 172 that is used within a control system 170 to generate the reference air pressure P_{rAd}. The output signal P_{aMd} is preferably electrical in order to reduce the friction within the dosing unit; if the friction in the dosing unit 140 is sufficiently low, then this electrical feedback of P_{aMd} to the regulator 172 will not be necessary. This is the case, for example, where the dosing unit 140 uses a membrane instead of the piston 145, especially for spraying paint in low-pressure applications.

The reference pressure P_{rAd} applied to the dosing unit 140 may be determined using known methods. In the illustrated embodiment, the control system 170 determines P_{rAd} given a reference flow value Qᵣ and the measurement of the dosing pressure P_{aMd} at the dosing unit 140. U.S. Pat. No. 5,182,704 (Bengtsson, 26 Jan. 1993, “Method and Device for Regulating the Spraying of Coating Materials”) discloses one suitable system and method for generating an output control pressure as a function of a input reference flow signal Qᵣ and the dosing pressure P_{aMd}. In the disclosed system, a model (or a function or a table), which is used to estimate a pressure to be used to achieve a desired flow rate, is continuously updated with information from a flow-measuring device. An additional feature of the disclosed system is that it also accounts for the viscosity of the material to be sprayed. The system and method described in U.S. Pat. No. 5,182,704 may be used to implement all of part of the control system 170, and is incorporated here by reference. The disclosed method may also be used to improve the regulation of the flow pump 110.

In the illustrated embodiment, the input signal or value to the control system 170 is the reference flow value Qᵣ, which may be set using any known mechanism depending on the needs of a given application of the invention. The signal or value Qᵣ is advantageously input to a viscosity-adaptive flow-pressure-function (FPF) 174 as in U.S. Pat. No. 5,182,704, which may be implemented in hardware, firmware and/or software using any known technique, such as expression evaluations or pre-computed look-up tables, and which provides a proper value for a reference material pressure P_{rMd}.

The output from the FPF module 174 is therefore the reference dosage material pressure P_{rMd}, which is also fed forward as an additive input to a standard regulator 172, whose output signal is such that it attempts to force its input to null, or to some set value. In this case, the regulator 172 output signal, which is added to P_{rMd}, influences the reference air pressure P_{rAd} to try to cause P_{rMd} and P_{aMd} to be equalized. In other words, P_{rMd} is the target pressure for the dosing unit 140, and the regulator 172 adjusts the reference pressure into the dosing unit so that the dosing unit's actual pressure will match this target pressure.

The output of the regulator 170 is added to P_{rMd}, and the sum of these signals is optionally scaled by a gain element 176 to provide the reference pressure P_{rAd} within the proper signal range to the dosing unit 140.

The principle of control used in the embodiment of the invention illustrated in FIGS. 2 and 3 is that the dosing unit 140 controls pressure to the gun 150 whereas the first pump 110 controls flow into the system. As long as the dosing unit 140 does not become empty or full when the gun 150 is on and spraying material, the system will work well. Note that avoiding volume extremes in either “direction”(completely empty or completely full) helps reduce the demand on the response time of the flow pump 110 and allows the dosing unit to respond to both increases and decreases in required pressure.

The total material flow in Q_{aMg} nozzle(s) N1, N2, N3 of the spray gun 150 is the sum of the pump flow Q_{aMp}, the dosing unit 140 flow Q_{aMd}, and the flows Q_{aAcc1}, and Q_{aAcc2} caused by accumulation in the hoses 130, 131. The time constant of the hose accumulation is typically about one second. For steady-state flow, the hose accumulations will not matter, in which case Q_{aMg}=Q_{aMp}+Q_{aMd}. If this does not hold, either generally, or at any given time, then a different trajectory in the FPF profile 174 should be used, or the FPF itself will need recalibration.

A valve 161, such as a check valve, a 3/2 valve, or any other equivalent conventional valve, may also be installed in front of the material input to the dosing unit 140. Such a valve 161 would make it possible to avoid pressurizing the first hose between the flow pump 110 and the dosing unit 140 when the pressure rises. This would also allow the use of a dosing unit 140 with a smaller total volume. Moreover, if one wishes to have a continuously lower pressure than the input pressure P_{Supply}, then this can be accomplished by closing the inlet valve 161 when the spray gun is shut off.

In order to ensure both stability in the control system 170 and that the dosing unit 140 does not bottom out in either direction, the flow of material into the dosing unit 140 must be controlled. The nominal state of the dosing unit 140 is to be at its maximum allowable fill level (although, preferably, not completely full) when its pressure is at the lowest desired value.

See FIG. 3, which illustrates by way of example one method for converting the desired or reference material spray pressure P_{rMd} into a desired material flow value Q_{rMp}, and then for converting the flow value Qᵣₘₚ into the reference air pressure P_{rAp}. The control characteristics illustrated in FIG. 3 may be implemented using any known hardware, firmware, and/or software techniques and components to make up the module 200 shown in FIG. 2 for converting P_{rMd} to P_{rAp}. Note that the module 200 may also be included physically and/or conceptually as part of the control system 170 to constitute a common feedback control system inasmuch components 170 and 200 together generate the input signal (as illustrated, P_{rAp}) to the flow pump 110 as a function of various parameters and other values measured downstream from the pump 110.

Let V_{ref} be a reference volume for the dosing unit 140. This reference volume can be chosen in different ways, and will normally be a design parameter set (permanently or adjustably) in the conversion module 200. In order to optimally use a dosing unit 140 of a given size one can choose V_{ref} to be, for example, a function of the desired spray pressure P_{rMd} and the accumulating effect of the hoses 130, 131:

V_{ref}=Vₘₐₓ−K_{acc}·P_{rMd}

where Vₘₐₓ is the total volume of the dosing unit 140; and K_{acc} is a gain factor, chosen to have the dimension corresponding to volume/pressure. Note that, in this expression, −K_{acc} is the slope of the pressure-to-volume function of the dosing unit, which is in turn a function of hose accumulation (assuming the material to be sprayed is essentially incompressible).

If the maximum desired spray pressure Pₘₐₓ is too large relative to the given dosing volume V_{aMd} and the hose accumulation effect, then there may be problems. It might then, for example, not be possible to raise the pressure to the desired level with the given dosing volume. Therefore, is best if: Pₘₐₓ·K_{acc}<Vₘₐₓ

Tests have indicated that a suitable value for the maximum dosing volume is 2·Pₘₐₓ·K_{acc}. If K_{acc} is set greater than the static hose accumulation, then the pump flow may be allowed to be “a periodic” when the spray gun 150 is first activated and pressure increases. When the gun is shut off and the pressure changes to a lower flow, the pump flow will also lag behind.

Once the reference volume V_{ref} is determined, it is compared with the actual material volume V_{aMd} in the dosing unit, as sensed by the position sensor 146. The difference V_{ref}−V_{aMd} is then a volume error signal Vₑ:

Vₑ=V_{ref}−V_{aMd}

This error value is converted to a flow value by scaling by a suitably dimensioned gain factor K_{pvq} to form a reference flow correction value Q_{radd}, which is added to the desired reference flow Qᵣto form the reference material flow value Q_{rMp}. In other words, given the reference flow Qᵣ, the correction value Q_{radd} indicates how much more (or less) flow the pump 110 should produce.

One should avoid too low values of K_{acc}. In particular, K_{acc} should not be chosen to be less than the accumulation constant of the hoses. Conversely, the gain factor K_{pvq} for the dosing volume error Vₑ to the flow correction value Q_{radd} should not be set too high. K_{Ppvq}=1 corresponds, for example, to a time constant of one second for the flow correction value Q_{radd}. It would be possible to include a lead filter, for example, a PD regulator, instead of the gain K_{pvq} in FIG. 3; this would speed up the pump 110 somewhat.

If the source 10 (in the example, the first pump 110) is flow-controlled rather than pressure-controlled, then Q_{rMp} may itself be the input signal to the first pump, with no further processing required. In the illustrated embodiment, however, input reference signal to the first pump is P_{rAp}. FIG. 3 also illustrates how Q_{rMp} can then be converted to the reference air pressure P_{rAp} that is applied as the input signal to the valve pump 120:

The difference between the desired flow Q_{rMp} and the current, actual flow value Q_{aMp} is formed to produce a flow error signal Qₑ. Recall that Q_{aMp} can be computed as the time derivative of the material volume V_{aMp} in the pump 110 unit, which is measured using the sensor 116. Thus:

$${Q}_{e} = ( {Q}_{rMP} - {Q}_{aMP} ) = {Q}_{rMP} - \frac{ⅆ {V}_{aMp}}{ⅆ t}$$

Given an error signal such as Qₑ, any known regulator, such as a standard analog or digital PD (or PID) regulator 300, may be included and adjusted using known design methods to output the reference air pressure P_{rAp} that will tend to equalize Q_{rMp} and Q_{aMp}. In general, as the error Qₑ increases, so to will P_{rAp}, since this will cause the flow pump 110 to increase its output.

When the spray gun 150 is first activated, the dosing volume error Vₑ is normally negative. This means that the dosing unit 140 contains “too much” material: Q_{radd}=−Qᵣ and the pump 110 is standing still. The dosing volume V_{aMd} and also Q_{radd} then approach zero as the pump begins supplying flow to the gun, since the reference air pressure P_{rAp} will be caused to rise. When the spray gun is shut off, the dosing unit 140 takes control of the flow from the pump 110 and the volume in the dosing unit 140 increases. In other words, the dosing unit 140 can correct the pressure P_{rAp} even when the gun is shut off. The effect of this is that the dosing unit 140 acts as an accumulator —but an active accumulator—in that it can direct the flow pump 110 to increase or decrease its output, and thus the volume of material in the cylinder 142 of the dosing unit, substantially independently of the current activity of the spray gun 150. Indeed, even while the gun is spraying, the dosing unit is able to adjust its reservoir of material to maintain an appropriate volume (which is not necessarily always “completely full,” for example), to avoid bottoming out in either direction, while still also maintaining a proper material deliver pressure P_{aMd} to the gun.

The procedure to be followed in using the invention is preferably the following: First, the user chooses and sets which flow Qᵣ is desired. Second, an appropriate pressure value P_{rAd} is calculated and the dosing unit 140 is pressurized to this value. Both Qᵣ and P_{rAd} will depend on the needs of a given job and the dimensions and specifications of the particular dosing unit 140 used; both of these input parameters may be chosen or computed using known design and operational methods. Other parameters such as Vₘₐₓ will be known or can be determined in advance and can be set using normal methods. Finally, the spray gun is opened (activated) and material is sprayed. This procedure also serves to illustrate the simple operation of a spray system configured as in this invention.

Several different input signals are applied to the various components of the illustrated embodiment of the invention. For example, Qᵣ is input to the control system 170, 200; P_{rAd} is applied to the dosing unit 140; and P_{rAp} and P_{aAp} are applied directly or indirectly to the flow pump 110. Especially pressure signals could, and probably will be, physical, meaning that an actual pressure is being applied to a mechanical member in the respective component. Any or all of these signals could also be electrical—even digital—however, so as to drive corresponding actuators.

As FIG. 2 illustrates, a pressure transducer 162 may also be included at the input of the spray gun 150 in order to provide a signal P_{aMg} indicating the actual material pressure at this point. This signal, although not essential to controlling the flow from the source (for example, Q_{aMp} from the first pump 110) or the reference pressure P_{rAd} applied to the dosing unit 140, may nonetheless be used to determine other characteristics of the system and improve the control function. For example, assuming the spray gun is shut off, the pressure differential (P_{aMg}−P_{aMd}) between the transducers 162 and 160 may be used to calculate an approximation of the viscosity of the material under the instantaneous, ambient conditions. Similarly, the pressure differential (P_{aMg}−P_{aMp}) would indicate viscosity of the material between the transducers 162 and 132. By measuring the differential(s) at different times, under different ambient conditions, the viscosity-adaptive flow-pressure-function (FPF) 174 used in the control system 170 could be compiled.

The signal to turn the gun on or off is usually electrical, whereas the actual opening and closing is a much slower mechanical process. The pressure change between the transducers 160 and 162 when the spray gun is first turned on or shut off indicates very accurately the exact time of gun opening and closing. This observation can be exploited by any monitoring or control system that takes such times into account, for example to calculate the time lag or lead needed to turn the gun on and off. Any conventional circuitry and/or software can then be included in the system to monitor (P_{aMg}−P_{aMd}) for this purpose.

The first hose 130 forms a material channel that extends from the first pump 110 (or other source) to the dosing unit 140. Similarly, the second hose 131 forms a material channel from the dosing unit to the gun 150. The differential pressure over the first channel can be defined as D_{dp}=(P_{aMd}−P_{aMp}); the differential pressure over the second channel can be defined as D_{gd}=(P_{aMg}−P_{aMd}), respectively. Note that both D_{dp} and D_{gd} are functions of time.

Assume now that an impulsive rise in pressure occurs, for example as a result of a “pulse” or “ramp” of material being applied by the source 10 (FIG. 1). This could be done as part of a calibration procedure, for example. Assuming there is some elasticity in the hose 130, the pressure P_{aMp} will tend to rise faster than the pressure P_{aMd} measured by transducer 160. The pressure waveform sensed by the transducer 160 will then be determined by the transfer function of the first channel, which in turn is related to the impulse response of the channel. The transducer 162 will sense the impulse response for both the first and second channels. An impulse response could also be measured when the spray gun is abruptly shut off.

The system could also estimate the transfer function of the channel(s) even in real time, on-line, that is, as the spray gun is operational. Suitable techniques to accomplish this would include a Kalman filter, time-series (for example, ARMA or ARIMA) modeling of the channel(s) as a stationary stochastic process, etc.

In non-branched elastic channels with at most minor impedance mismatches, the impulse response function is usually roughly exponential, with a characteristic time constant. Knowledge of this time constant, or of the entire transfer or impulse response function, may then be used to adjust the parameters in any known adaptive regulator within the control system so as to better provide a smooth flow to the spray gun both when it is first activated and when it is shut off.

What is claimed is:

1. A system for spraying an at least substantially fluid material comprising:
a source providing a controllable flow of the material to be sprayed;
a dosing unit that receives the flow of material from the source, that holds a quantity of the material in a reservoir, and that outputs the material to a dispensing device; and
a control arrangement that has as an input signal an indication of a fill level of the reservoir and that outputs a flow control signal to the source such that the fill level in the reservoir is maintained less than a maximum level and greater than a minimum level when the dispensing device is active, the dosing unit thereby forming an active accumulator able to both receive material from the source and deliver material to the dispensing device at the same time.

2. A system as in claim 1, further comprising:
a dosing pressure sensor that generates a dosing pressure signal corresponding to a dosing pressure of material from the dosing unit to the dispensing device;
a pressure adjustment arrangement in the dosing unit that adjusts a pressure applied to the reservoir in response to a dosing control signal;
in which the control arrangement has, as additional input signals, the dosing pressure signal and a reference flow value, and generates the dosing control signal such that the pressure adjustment arrangement adjusts the dosing pressure to cause a material flow from the dispensing device to be at least substantially equal to the reference flow value when the dispensing device is activated.

3. A system as in claim 2, in which:
the source includes a first pump;
the dosing unit comprises a second pump;
the first pump produces a pump output flow of the material in response to the flow control signal; and
the second pump receives the material output under pressure from the first pump and holds a dosage volume of the material in the reservoir; and
the control arrangement generates the flow control signal also as a function of the pump output flow.

4. A system as in claim 3, in which the first pump is a constant displacement flow pump.

5. A system as in claim 4, in which the first pump is a pneumatically controlled piston pump.

6. A system as in claim 5, in which the first pump is a 4-ball pump.

7. A system as in claim 2, in which the control arrangement:
generates the flow control signal also as a function of the pump output flow and the reference flow value; and
generates the flow control signal and the dosing control signal such that the reservoir of the second pump is gradually filled with material when the dispensing device is not dispensing material.

8. A system as in claim 1, in which:
the fluid material includes inhomogeneities;
all material passages in a flow path through the source and the dosing unit are larger than a maximum dimension of the inhomogeneities, which thereby pass undestroyed through the flow path.

9. A system as in claim 8, in which the material is a PVC material and the inhomogeneities have lower density than the PVC.

10. A system as in claim 9, in which the inhomogeneities are made of glass.

11. A system as in claim 2, in which the reservoir of the dosing unit is a piston-cylinder.

12. A system as in claim 2, further comprising a first elastic hose connecting the first pump to the second pump and having a first accumulation volume, in which the reservoir of the dosing unit has a maximum operating volume that exceeds the first accumulation volume over an operating pressure region.

13. A system for spraying an at least substantially fluid material comprising:
a source including a first pump providing a controllable source output flow of the material to be sprayed;
a flow sensor that generates a flow signal indicating the source output flow;
a dosing unit comprising a second pump that receives the output flow of material from the source, that holds a dosage volume of the material in a reservoir, and that delivers the material to a dispensing device;
a volume sensor that generates a volume signal indicating a fill level of the reservoir;
a dosing pressure sensor that generates a dosing pressure signal corresponding to a dosing pressure of material from the dosing unit to the dispensing device;
a pressure adjustment arrangement in the dosing unit that adjusts a pressure applied to the reservoir in response to a dosing control signal;
a control arrangement that outputs:
a flow control signal to the source as a function of the volume signal, the flow signal, and a reference flow value, such that the fill level in the reservoir is maintained less than a maximum level and greater than a minimum level when the dispensing device is active, the dosing unit thereby forming an active accumulator able to both receive material from the source and deliver material to the dispensing device at the same time; and
the dosing control signal as a function of the dosing pressure signal and the reference flow value such that the pressure adjustment arrangement adjusts the dosing pressure to cause a material flow from the dispensing device at least substantially equal to the reference flow value when the dispensing device is activated.

14. In a system for spraying a material that includes a source providing a flow of the material to be sprayed, in which a flow path is defined from an output of the source to an input of a dispensing device, a method for estimating viscosity of the material comprising:
measuring the pressure of the material at a pair of points in the flow path; and
computing an estimate of the viscosity of the material as a function of a pressure differential between the pair of points.

15. In a system for spraying a material that includes a source providing a flow of the material to be sprayed, in which a flow path is defined from an output of the source to an input of a dispensing device, a method for estimating a time at which the dispensing device is activated comprising:
measuring the pressure of the material at a pair of points in the flow path; and
estimating an initial activation time of the dispensing device as a function of a pressure differential between the pair of points.
